(19) United States
(12) Patent Application Publication
(10) Pub. No.: US 2011/0050549 A1
(43) Pub. Date: Mar. 3, 2011

(54) Image Display Device

(75) Inventors: Akihiko YAMADA, Daito City (JP); Haruo HATANAKA, Kyoto City (JP); Toshitaka KUMA, Osaka City (JP)

(73) Assignee: SANYO ELECTRIC CO., LTD., Osaka (JP)

(21) Appl. No.: 12/869,840

(22) Filed: Aug. 27, 2010

(30) Foreign Application Priority Data
Aug. 27, 2009 (JP) 2009-197041

(51) Int. Cl. G09G 3/20

(52) U.S. Cl. 345/55

(57) ABSTRACT

Provided is an image display device which displays corresponding images corresponding to image data items classified into categories. In particular, the image display device preferentially displays a corresponding image corresponding to an image data item which belongs to a representative category selected from the categories.

This application is based on Japanese Patent Application No. 2009-197041 filed on Aug. 27, 2009, the contents of which are hereby incorporated by reference.

### BACKGROUND OF THE INVENTION

1. Field of the Invention

The present invention relates to an image display device which displays an image.

2. Description of Related Art

A digital image taking device, which stores taken images (including moving images and still images) on a storage medium as data instead of on a film, is widely used. In such an image taking device, the number of storable image data items is limited depending on a capacity of the storage medium. However, because a large-capacity storage medium has been realized in recent years, a user is able to take and store a large number of image data items with no stress.

However, when the number of image data items stored on the storage medium becomes significantly large, it becomes difficult to search for desired image data from the storage medium.

Therefore, there has been proposed an image display device which displays reduced images of the image data items together with a calendar, to thereby enable the user to search for the desired image data by following a clue such as the day, the week, or the month when the image is taken. Further, when there exist a plurality of image data items on the same day, the same week, or the same month, the image display device displays as many reduced images as can be displayed.

However, in the image display device described above, when there exist a large number of image data items on the same day, the same week, or the same month, the reduced image of the desired image data is not always displayed by luck. Further, if the reduced image of the desired image data is not displayed, the search for the desired image data becomes difficult.

### SUMMARY OF THE INVENTION

An image display device according to the present invention includes a display unit which displays corresponding images corresponding to image data items classified into categories, in which the display unit preferentially displays a corresponding image corresponding to an image data item which belongs to a representative category selected from the categories.

### BRIEF DESCRIPTION OF THE DRAWINGS

In the accompanying drawings:

FIG. 1 is a block diagram illustrating an example of a configuration of an image display device according to an embodiment of the present invention;

FIG. 2 is a block diagram illustrating an example of a configuration of an image taking device;

FIG. 3 is a flow chart illustrating an operation of a storage system;

FIG. 4 is a flow chart illustrating an operation of a display system;

FIG. 5 is a graph illustrating an example of an automatic determination method for a category;

FIG. 6 is a diagram illustrating an example of a calculation method for a feature vector;

FIG. 7 is a diagram illustrating the example of the calculation method for the feature vector;

FIG. 8 is a diagram illustrating an example of a display image;

FIG. 9 is a diagram illustrating an example of a method of selecting a corresponding image to be displayed in the display image;

FIG. 10 is a diagram illustrating an example of a display image when a representative category different from that of the display image illustrated in FIG. 8 is selected;

FIG. 11 is a diagram illustrating another example of the display image;

FIG. 12A is a diagram illustrating an example of a search method for image data;

FIG. 12B is a diagram illustrating the example of the search method for the image data;

FIG. 13 is a diagram illustrating an example of a display image generated by switching the display image illustrated in FIG. 8; and

FIG. 14 is a diagram illustrating an example of a display image showing corresponding images in spatial sections.

### DETAILED DESCRIPTION OF PREFERRED EMBODIMENT

Significance and effects of the present invention become apparent from the following description of an embodiment. Note that, the following embodiment is merely one of the embodiments of the present invention, and meanings of terms used to describe the present invention and components thereof are not limited to those described in the following embodiment.

<<Overall Configurations of Image display Device and Image Taking Device>>

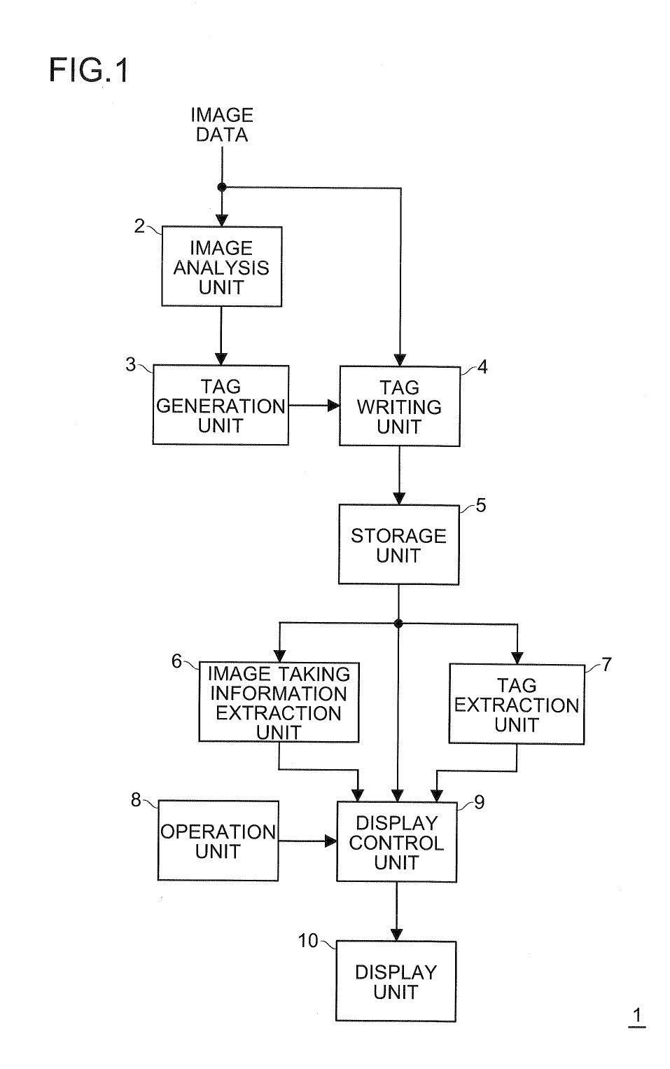

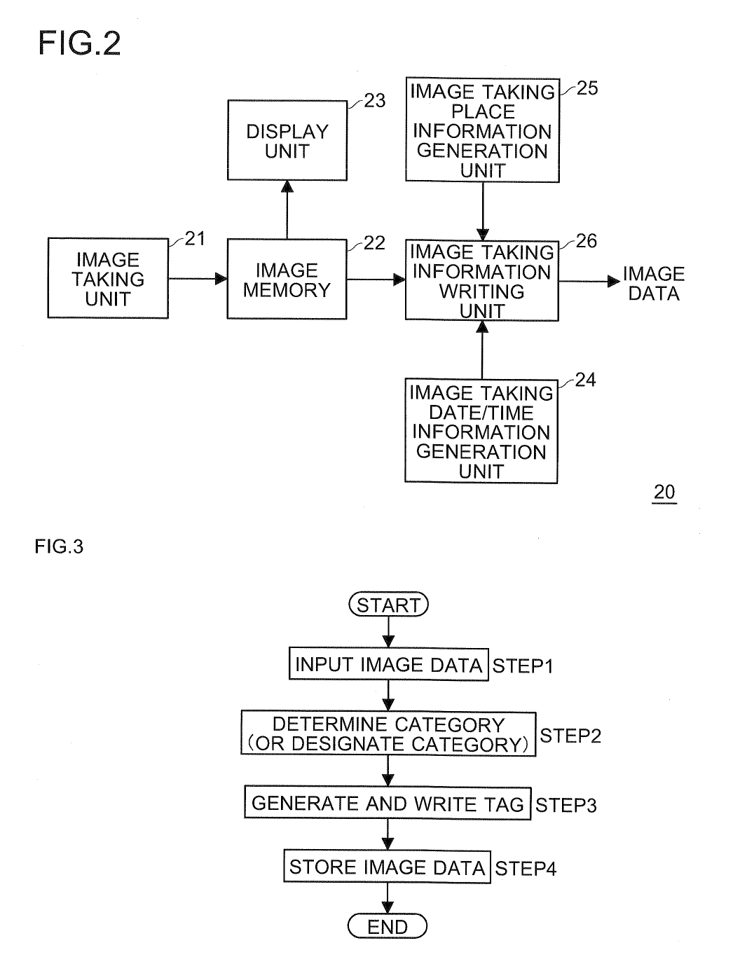

Hereinafter, the embodiment of the present invention is described with reference to the drawings. First, overall configurations of an image display device and an image taking device are described with reference to the drawings. FIG. 1 is a block diagram illustrating an example of the configuration of the image display device according to the embodiment of the present invention. FIG. 2 is a block diagram illustrating an example of the configuration of the image taking device.

As illustrated in FIG. 1, an image display device 1 includes: an image analysis unit 2 which performs an image analysis for input image data to determine a category to which the image data belongs; a tag generation unit 3 which generates a tag based on a determination result obtained by the image analysis unit 2; a tag writing unit 4 which writes the tag generated in the tag generation unit 3 into a predetermined region (for example, header) of the image data; a storage unit 5 which stores the image data containing the tag written by the tag writing unit 4; an image taking information extraction unit 6 which extracts image taking information from the image data stored in the storage unit 5; a tag extraction unit 7 which extracts the tag from the image data stored in the storage unit 5; an operation unit 8 through which a user instruction is input; a display control unit 9 which reads out necessary data from the storage unit 5 based on the image taking information acquired from the image taking information extraction unit 6, the tag acquired from the tag extraction unit 7, and the user instruction which is input through the operation unit 8, and then adjusts the read-out necessary data, to thereby generate an image displayed for the user (hereinafter, referred to as display image); and a display unit 10 which displays the display image generated in the display control unit 9.

“Tag” mainly indicates the category to which the image data belongs. “Category” refers to classification in accordance with subjects in the image data, such as food, a train, a cat, a dog, a portrait (adult, child, man, woman, or particular person). “Image taking information” mainly refers to information which indicates a situation (for example, image taking date/time or image taking place) at a time when the image data is obtained by an image taking operation.

Note that, the image analysis unit 2, the tag generation unit 3, the tag writing unit 4, and the storage unit 5 are assumed as a block of a storage system, and the storage unit 5, the image taking information extraction unit 6, the tag extraction unit 7, the operation unit 8, the display control unit 9, and the display unit 10 are assumed as a block of a display system.

Further, as illustrated in FIG. 2, an image taking device 20 includes: an image taking unit 21 which includes a solid-state image taking element such as a charge coupled device (CCD) and a complementary metal oxide semiconductor (CMOS) and generates image data by an image taking operation; an image memory 22 which temporarily stores the image data obtained by the image taking unit 21; a display unit 23 which displays the image data stored in the image memory 22; an image taking date/time information generation unit 24 which generates, by recognizing an image taking date/time when the image has been taken, image taking date/time information which is information indicating the image taking date/time; an image taking place information generation unit 25 which generates, by recognizing an image taking place where the image has been taken, image taking place information which is information indicating the image taking place; and an image taking information writing unit 26 which writes the image taking date/time information generated in the image taking date/time information generation unit 24 and the image taking place information generated in the image taking place information generation unit 25 into a predetermined region (for example, header) of the image data stored in the image memory 22.

The image data output from the image taking information writing unit 26 may be temporarily stored in a storage unit (not shown) and then transferred to the image display device 1 of FIG. 1, or may be directly transferred to the image display device 1. In this manner, the image data is input to the image display device 1.

Note that, the storage unit of the image taking device may be detached from the image taking device 20 to be connected to the image display device 1, to thereby input the image data to the image display device 1.

Further, although the image display device 1 of FIG. 1 includes both the block of the storage system and the block of the display system, the image display device 1 may include only the block of the display system. In this case, the image taking device 20 may include the block of the storage system instead of the image display device 1. In addition, in this case, any one of the writing of the image taking information by the image taking information writing unit 26 and the writing of the tag by the tag writing unit 4 may be performed first in the image taking device 20.

Further, the image display device 1 of FIG. 1 and the image taking device 20 of FIG. 2 may be integrally provided. In addition, in this case, the display unit 10 of FIG. 1 and the display unit 23 of FIG. 2 may be the same unit.

Further, although the image taking device 20 including both the image taking date/time information generation unit 24 and the image taking place information generation unit 25 is described above, the image taking device 20 may include any one of the image taking date/time information generation unit 24 and the image taking place information generation unit 25 (for example, image taking date/time information generation unit 24) alone. However, for concrete description, the case where the image taking device 20 includes both the image taking date/time information generation unit 24 and the image taking place information generation unit 25 is described below.

Next, operations of the image taking device 20 and the image display device 1 are described with reference to the drawings. First, the operation of the image taking device 20 is described.

As illustrated in FIG. 2, in the image taking device 20, the image taking unit 21 first generates the image data by an image taking operation. At this time, the image taking date/time information generation unit 24 recognizes the image taking date/time based on, for example, a timer included in the image taking device 20, and generates the image taking date/time information. On the other hand, the image taking place information generation unit 25 recognizes the image taking place based on, for example, a global positioning system (GPS) included in the image taking device 20, and generates the image taking place information.

After the image data is generated in the image taking unit 21, the image data is temporarily stored in the image memory 22. The user may check the taken image, by displaying the image data stored in the image memory 22 on the display unit 23. Further, the image taking information writing unit 26 acquires the image taking date/time information from the image taking date/time information generation unit 24, and also acquires the image taking place information from the image taking place information generation unit 25. After that, the image taking information writing unit 26 writes those pieces of image taking information into the predetermined region in the display data. In this manner, the image data is generated by the image taking device 20.

Next, the operation of the image display device 1 is described with reference to the drawings. First, an operation of the storage system is described with reference to the drawing. FIG. 3 is a flow chart illustrating the operation of the storage system.

As illustrated in FIG. 3, first, the image data is input to the image analysis unit 2 of the image display device (STEP 1). As described above, the image data is input from the image taking device 20. Note that, when the image display device 1 and the image taking device 20 are integrally provided, the image data output from the image taking unit 21 or the image memory 22 may be directly input to the image analysis unit 2.

The image analysis unit 2 analyzes an image represented by the image data (hereinafter, also simply referred to as image), and automatically determines the category to which the image data belongs (STEP 2). Details of an analysis method for the image and an automatic determination method for the category of the image data by the image analysis unit 2 are described later. Note that, in addition to (or instead of) the automatic determination of the category of the image data by the image analysis unit 2 performed in STEP 2, manual designation of the category of the image data by the user may be performed. Further, categories to be automatically determined by the image analysis unit 2 may be designated by the user.

The tag generation unit 3 generates a tag indicating the category which is automatically determined by the image analysis unit 2 (or manually designated). Then, the tag writing unit 4 writes the tag generated by the tag generation unit 3 into the predetermined region of the image data (STEP 3), and stores the image data in the storage unit 5 (STEP 4). In this manner, the operation of the storage system is completed.

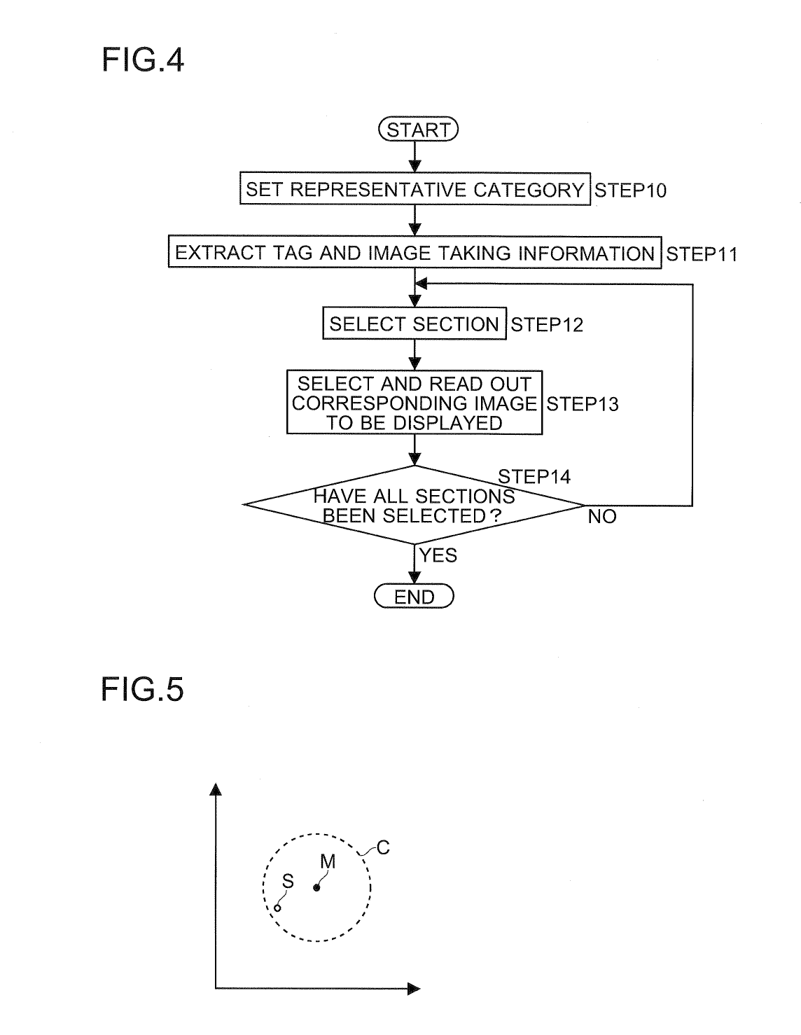

Next, an operation of the display system, in particular, the operation of generating the display image by the display control unit 9, is described with reference to the drawing. FIG. 4 is a flow chart illustrating the operation of the display system.

As illustrated in FIG. 4, first, the display control unit 9 selects at least one of the categories described above, and sets the selected category as a representative category (STEP 10). The representative category may be a category set based on the instruction from the user input through the operation unit 8 when the display image is generated, may be a category set by the user in advance, or may be a category set automatically by the display control unit 9.

Next, the image taking information extraction unit 6 extracts the image taking information from the predetermined region (for example, header region) of the image data which is stored in the storage unit 5. Further, similarly, the tag extraction unit 7 extracts the tag from the predetermined region of the image data which is stored in the storage unit 5 (STEP 11). The extracted image taking information and tag are input to the display control unit 9. Note that, at this time, the display control unit 9 may read out other data (for example, data of frame of display image) which may be necessary to generate the display image from the storage unit 5.

The display image includes sections in which corresponding images of the image data items are displayed. Note that, the corresponding images displayed in the sections are only the corresponding images selected by the display control unit 9. Note that, there may be sections where corresponding images are not displayed. Details of the display image and a method of selecting the corresponding images to be displayed in the sections are described later.

“Corresponding image” refers to, for example, a thumbnail image attached to the image data or an image obtained by adjusting the image of the image data (for example, reduced image of still image or reduced image of one flame contained in moving image). Note that, the corresponding image is not limited to the images describe above, and may include, for example, a character or an icon, or may be an image obtained by combining the character and the icon with the images describe above.

Further, “section” refers to, for example, a temporal section of, for example, day, week, month, year, and predetermined day of the week on a calendar, a spatial section of, for example, village, town, city, prefecture, region, country, and predetermined distance area on a map, or a section of a combination thereof. Note that, the type and the number of the sections included in one display image may be set based on the instruction from the user input through the operation unit 8 when the display image is generated, may be set by the user in advance, or may be set automatically by the display control unit 9. Note that, for concrete description, a case where the corresponding images are displayed in the temporal sections is mainly described below.

The display control unit 9 selects one section (STEP 12). Then, the display control unit 9 selects the corresponding image which is to be displayed in the section, and reads out the corresponding image from the storage unit 5 (STEP 13). The display control unit 9 generates the display image by displaying the read-out corresponding image in the section.

In STEP 13, the display control unit 9 determines whether or not the corresponding image is an image which may be displayed in the section based on the image taking information on the image data. In addition, the display control unit 9 determines whether or not to display the corresponding image in the display image based on the tag of the image data and the representative category thereof.

After the corresponding image to be displayed in the section is selected and read out in STEP 13, the display control unit 9 checks whether or not there is an unselected section (STEP 14). When there is an unselected section (NO of STEP 14), the process returns to STEP 12 to select the unselected section. On the other hand, when selection of all the sections is completed (YES of STEP 14), the operation of the display system is completed.

The display unit 10 displays the display image generated by the display control unit 9. At this time, when a new instruction is input from the user through the operation unit 8, the display control unit 9 performs adjustment or regeneration of the display image in response to the instruction.

Note that, in the flow charts illustrated in FIGS. 3 and 4, the category is determined and the tag is generated when the image data is stored, and the category to which the image data belongs is recognized by referring to the tag extracted from the image data at the time of display. Alternatively, if possible, the determination of the category may be performed at the time of display. Note that, if the category is determined at the time of display, a calculation amount at the time of display becomes significantly large. Therefore, it is preferred that the category be determined in advance as described above.

<<Image Analysis Unit>>

Next, an example of the automatic determination method for the category of the image data by the image analysis unit is described with reference to the drawing. FIG. 5 is a graph illustrating the example of the automatic determination method for the category.

In the automatic determination method illustrated in FIG. 5, determination of the category is performed based on a feature amount of the image. For example, a difference between a feature amount S of an image of image data to be determined and a feature amount M of a sample of the category (when feature amounts are expressed by vectors, distance (Euclidean distance) difference between endpoints when start points of both vectors are assumed to be point of origin) is calculated. When the difference between the feature amounts S and M is small (for example, when difference between feature amounts S and M is equal to or lower than predetermined value, that is, when feature amount S is positioned within range C centered on feature amount M), the image data to be determined is determined to be data belonging to the category.

Note that, in FIG. 5, for simplicity of description, the feature amounts S and M are expressed as two-dimensional values, but the feature amounts S and M may be n-dimensional values (n is natural number). Further, in FIG. 5, the range C of the feature amount S of the image in a case where the image data belongs to a certain category is assumed as a range of a circle having the sample feature amount M as a center thereof (range of feature amount, in which difference from feature amount M is equal to or lower than predetermined value (radius)). Alternatively, the range may have a different shape.

<Feature Amount Calculation Example>

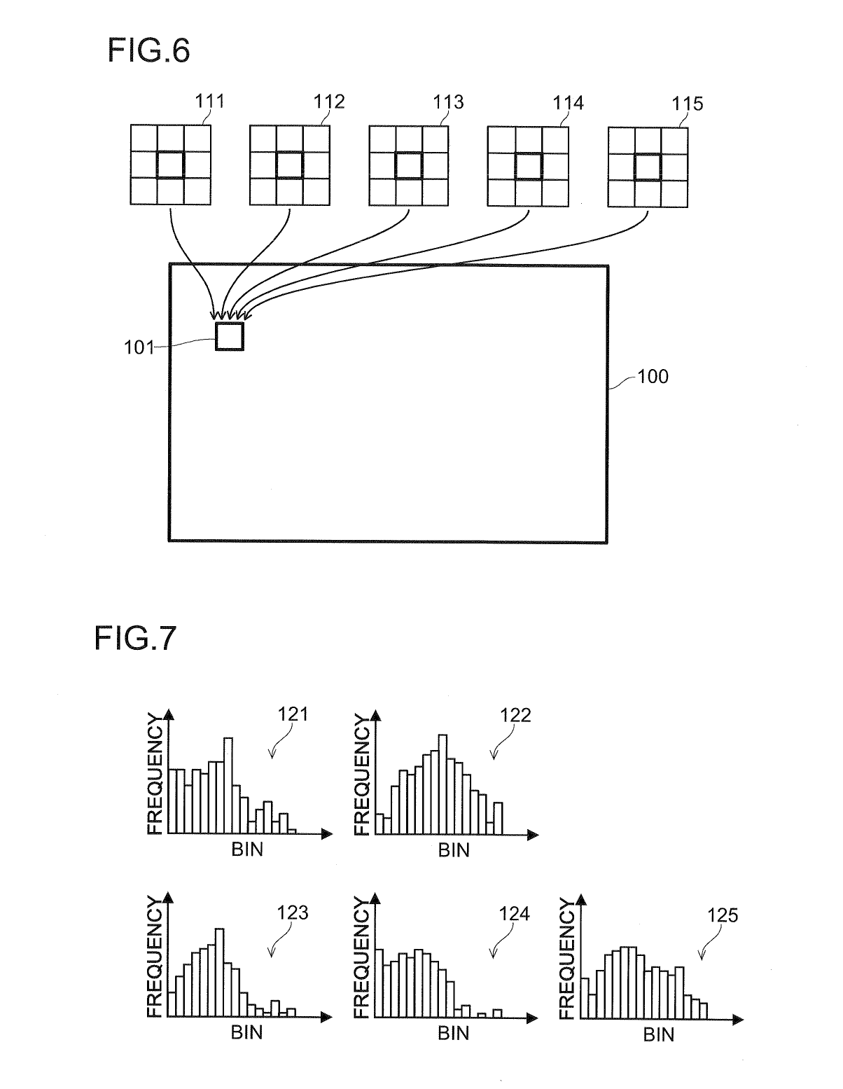

Further, the feature amount S may be a “feature vector”. Hereinafter, a method of calculating the “feature vector” is described with reference to the drawings. FIGS. 6 and 7 are diagrams illustrating an example of the method of calculating the feature vector.

An image 100 illustrated in FIG. 6 is a two-dimensional image including a plurality of pixels arranged in horizontal and vertical directions. Filters 111 to 115 are edge extracting filters which extract edges in a small region (for example, region in image 100 having 3×3 pixels) having a focused pixel 101 as a center thereof, in the image 100. As the edge extracting filters, arbitrary spatial filters appropriate for edge extraction (for example, differential filters such as Sobel filter or Prewitt filter) may be used. Note that, the filters 111 to 115 are different from one another. Further, in FIG. 6, a filter size of the filters 111 to 115 and the small region where the filters are caused to function are assumed to be 3×3 pixels as the example, but may be other sizes such as 5×5 pixels. Further, the number of filters to be used may be a number other than five.

The filters 111, 112, 113, and 114 extract edges extending in the horizontal direction, the vertical direction, a right oblique direction, and a left oblique direction of the image 100, respectively, and output filter output values indicating intensity of the extracted edges. The filter 115 extracts an edge extending in a direction not classified in the horizontal direction, the vertical direction, the right oblique direction, and the left oblique direction, and outputs a filter output value indicating intensity of the extracted edge.

The intensity of the edge represents a gradient magnitude of a pixel signal (for example, luminance signal). For example, when there is an edge extending in the horizontal direction of the image 100, a relatively large gradient occurs in the pixel signal in the vertical direction which is orthogonal to the horizontal direction. Further, for example, when spatial filtering is performed by causing the filter 111 to function on the small region having the focused pixel 101 at the center thereof, the gradient magnitude of the pixel signal along the vertical direction of the small region having the focused pixel 101 at the center thereof is obtained as the filter output value. Note that, this is common to the filters 112 to 115.

In a state where a certain pixel in the image 100 is determined as the focused pixel 101, the filters 111 to 115 are caused to function on the small region having the focused pixel 101 at the center thereof, to thereby obtain five filter output values. Among the five filter output values, the maximum filter output value is extracted as an adopted filter value. When the maximum filter output value is the filter output value obtained from one of the filters 111 to 115, the adopted filter value is called one of a first adopted filter value to a fifth adopted filter value. Therefore, for example, when the maximum filter output value is the filter output value from the filter 111, the adopted filter value is the first adopted filter value, and when the maximum filter output value is the filter output value from the filter 112, the adopted filter value is the second adopted filter value.

The position of the focused pixel 101 is caused to move from one pixel to another in the horizontal direction and the vertical direction in the image 100, for example. In each movement, the filter output values of the filters 111 to 115 are obtained, to thereby determine the adopted filter value. After the adopted filter values with respect to all the pixels in the image 100 are determined, histograms 121 to 125 of the first to fifth adopted filter values as illustrated in FIG. 7 are individually created.

The histogram 121 of the first adopted filter value is a histogram of the first adopted filter value obtained from the image 100. In the example illustrated in FIG. 7, the number of bins of the histogram is 16 (this is common to histograms 122 to 125). In this case, 16 frequency data items may be obtained from one histogram, and hence 80 frequency data items may be obtained from the histograms 121 to 125. An 80-dimensional vector having the 80 frequency data items as elements thereof is obtained as a shape vector H_{E}. The shape vector H_{E} is a vector corresponding to a shape of an object existing in the image 100.

In addition, color histograms representing a state of color in the image 100 are created. For example, when pixel signals in each pixel forming the image 100 include an R signal representing intensity of red color, a G signal representing intensity of green color, and a B signal representing intensity of blue color, a histogram HST_{R} of an R signal value, a histogram HST_{G} of a G signal value, and a histogram HST_{B} of a B signal value in the image 100 are created as the color histograms of the image 100. For example, when the number of bins of each color histogram is 16, 48 frequency data items may be obtained from the color histograms HST_{R}, HST_{G}, and HST_{B}. A vector (for example, 48-dimensional vector) having the frequency data items obtained from the color histograms as elements thereof is obtained as a color vector H_{C}.

When the feature vector of the image 100 is expressed by H, the feature vector H is obtained by an expression “H=k_{C}×H_{C}+k_{E}×H_{E}”, where k_{C} and k_{E} denote predetermined coefficients (note that, k_{C}≠0 and k_{E}≠0). Therefore, the feature vector H of the image 100 represents the feature amounts in accordance with a shape and color of an object in the image 100.

Note that, in a moving picture experts group (MPEG) 7, the derivation of the feature vector H (feature amount) of the image is performed by using five edge extracting filters, and the five edge extracting filters may be applied to the filters 111 to 115. In addition, the feature vector H (feature amount) of the image 100 may be derived by applying a method standardized in MPEG 7 to the image 100. Further, the feature vector H may be calculated by using only one of the feature amounts of a shape and color.

Further, in addition to (or instead of) the feature vector described above, the feature amount may be calculated based on existence of people (particularly, number of people) in the image. The existence of people in the image may be determined by, for example, using various known technologies for face detection. Specifically, for example, by using a weak learner which applies a weight table created from a large number of teacher samples (face and non-face sample images) by using Adaboost (Yoav Freund, Robert E. Schapire, “A decision-theoretic generalization of on-line learning and an application to boosting”, European Conference on Computational Learning Theory, Sep. 20, 1995.), a face may be detected from the image.

In addition, the feature amount may be calculated based on existence of a particular person in the image. The existence of a particular person in the image may be determined by, for example, using various known technologies for face recognition. Specifically, for example, the determination may be performed by comparing a sample image of a particular person stored in advance with a face of a person detected from the image by face detection.

Similarly, sexuality (male or female) or age (for example, adult or child) of a person detected from the image may be determined, to thereby calculate the feature amount based on the determination result.

Further, the above-mentioned feature vector may be calculated from a background region which is a region excluding a person region from the entire image. At this time, the person region may be a region in which a person is assumed to be contained based on a location and a size of a face region detected by face detection. When a person is not contained in the image, the entire image may be the background region.

<<Display Control Unit>>

<Basic Operation>

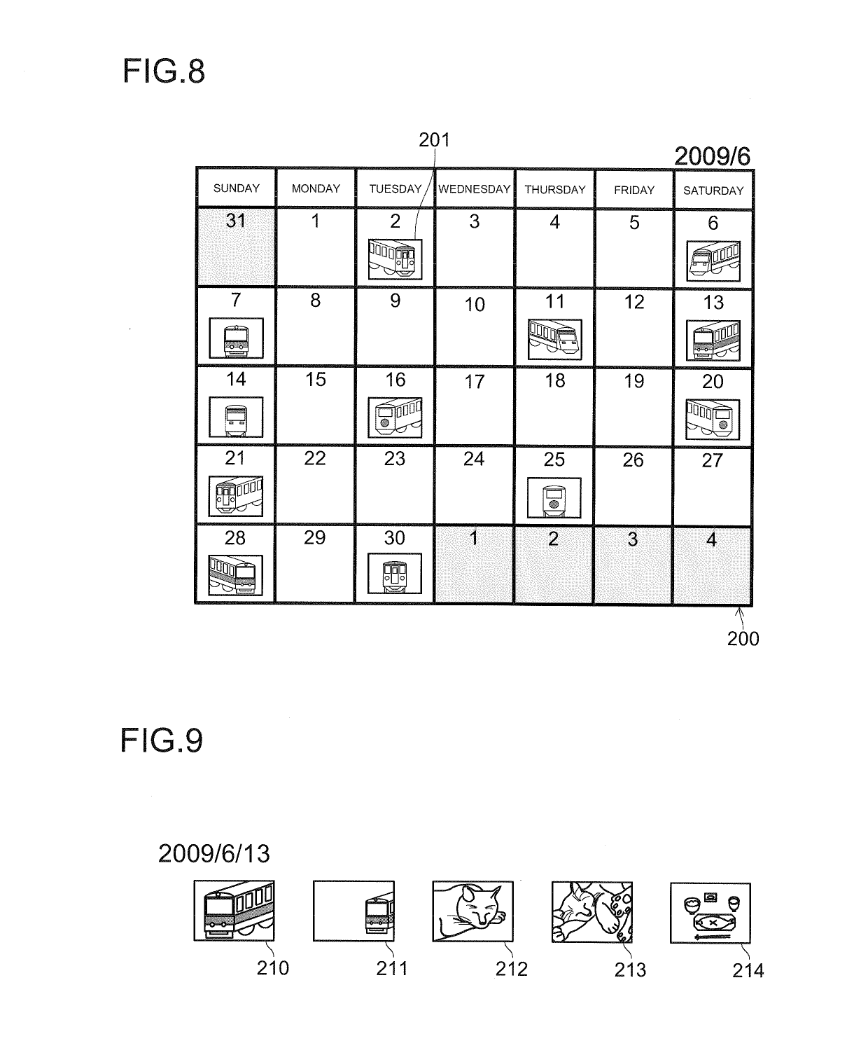

Next, an operation of generating the display image, which is a basic operation of the display control unit 9, is described with reference to the drawing. FIG. 8 is a diagram illustrating an example of the display image. A display image 200 illustrated in FIG. 8 has sections of days included in a certain month, and displays one corresponding image with respect to one day. Further, the representative category is “train”.

The display control unit 9 refers to the image taking date/time among the pieces of image taking information of the image data so as to generate the display image 200 illustrated in FIG. 8. Then, based on the image taking date/time thus referred to, the display control unit 9 determines whether or not the corresponding image of the image data is an image which may be displayed on a certain day in the display image 200 of FIG. 8. Specifically, if the image data is obtained on the certain day by an image taking operation, the corresponding image is determined to be an image which may be displayed on the certain day.

Further, among the images determined to be the corresponding images which may be displayed on the certain day, the display control unit 9 selects and displays the corresponding image belonging to the representative category preferentially.

Details of a method of selecting the corresponding image to be displayed in the display image are described with reference to the drawing. FIG. 9 is a diagram illustrating an example of the method of selecting the corresponding image to be displayed in the display image, and illustrates the corresponding images determined to be the images which may be displayed on the 13th day of the display image 200 illustrated in FIG. 8.

Among corresponding images 210 to 214 illustrated in FIG. 9, the corresponding images 210 and 211 belong to the category “train” which is the representative category. On the other hand, the corresponding images 212 and 213 belong to the category “cat”, and the corresponding image 214 belongs to the category “food”.

In this example, the corresponding images 210 and 211 of the image data items belonging to the category “train” which is the representative category are displayed preferentially. Note that, when the number of corresponding images which may be displayed in a certain section (13th day), that is, the number of corresponding images 210 and 211 (two) in which the image data items thereof belong to the representative category (train), is larger than the number of corresponding images (one) which is displayable in the certain section (13th day), the corresponding image 210 of the image data more matching to the representative category (more train like) may be selectively displayed.

The image data more matching to the representative category (more train like) is, for example, image data having smaller distance difference (hereinafter, referred to as “high in score”) between the feature amount S and the feature amount M illustrated in FIG. 5. In the corresponding images 210 and 211 illustrated in FIG. 9, the image data corresponding to the corresponding image 210 is higher in score than the image data corresponding to the corresponding image 211, and hence the corresponding image 210 is selected and displayed as the corresponding image displayed on the 13th day.

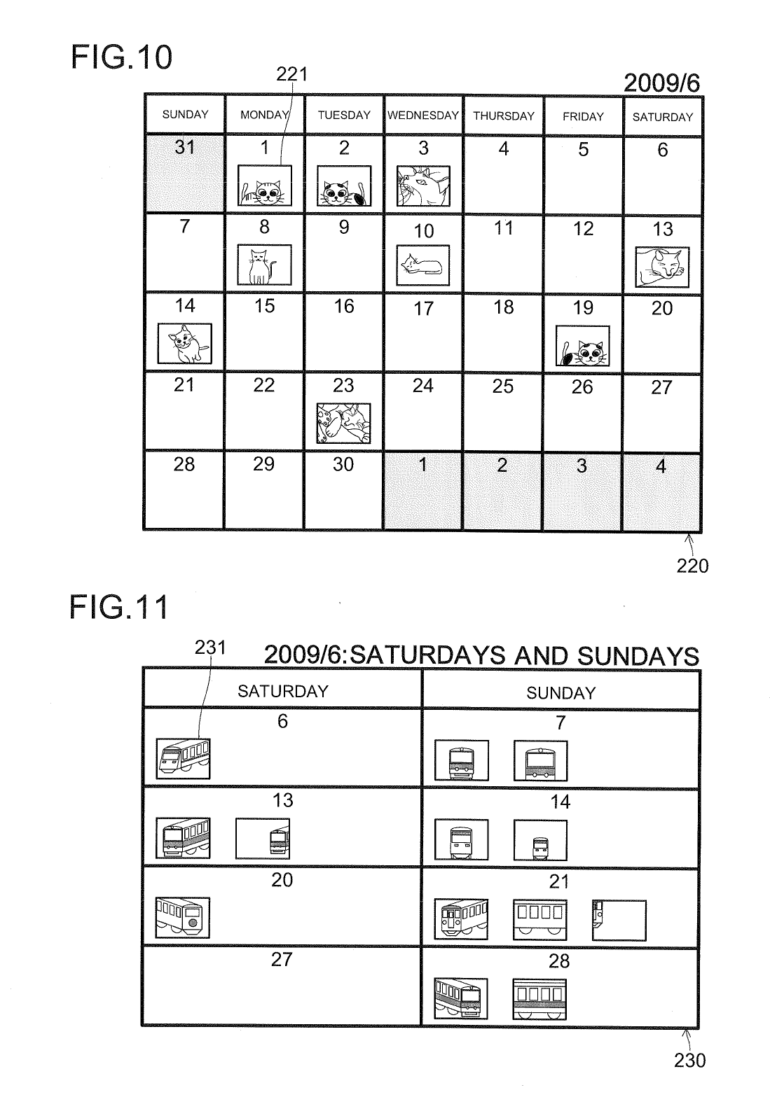

The representative category of the display image 200 may be changed. For example, when the instruction to change the representative category to “cat” is input by the user through the operation unit 8 while the display image 200 of FIG. 8 is being displayed on the display unit 10, the series of operations illustrated in FIG. 4 is executed again. In this manner, a display image 220 as illustrated in FIG. 10 is regenerated by the display control unit 9, and is displayed on the display unit 10. FIG. 10 is a diagram illustrating an example of the display image when a representative category which is different from that of the display image illustrated in FIG. 8 is selected. As illustrated in FIG. 10, corresponding images 221 belonging to the category “cat” are preferentially displayed in the display image 220.

With the configuration as described above, in the display images 200 and 220 displayed on the display unit 10, the corresponding images 201 and 221 belonging to the representative categories are preferentially displayed, respectively. Therefore, the user may easily and rapidly search for the desired image data by determining the category of the image data which is desired by the user as the representative category.

Note that, in the display images 200 and 220 illustrated in FIGS. 8 and 10, respectively, the corresponding images are not displayed in sections where the corresponding images belonging to the representative category “train” or “cat” do not exist (for example, 1st and 3rd to 5th days of FIG. 8). However, some images may be displayed in the sections. For example, a corresponding image belonging to a category other than the representative category may be displayed, or an image indicating that there is no corresponding image belonging to the representative category may be displayed.

Further, in the display images 200 and 220 illustrated in FIGS. 8 and 10, respectively, a display method in which one corresponding image 201 or 221 is displayed in each of the consecutive sections is employed. However, another display method may be employed. For example, a display method capable of displaying a plurality of corresponding images in intermittent sections may be employed. The display image generated by the above-mentioned display method is described with reference to the drawing. FIG. 11 is a diagram illustrating another example of the display image.

The representative category of a display image 230 illustrated in FIG. 11 is “train” similarly to FIG. 8. As illustrated in FIG. 11, only Saturdays and Sundays in one month are displayed as sections in the display image 230. Further, a plurality of corresponding images 231 are displayable in each of the sections.

With this configuration, for example, it is possible to selectively display corresponding images of the image data items in sections in which the image taking operation has been frequently performed. Further, for example, when the user recognizes the section of the desired image data, the corresponding images of the image data items in the section may be selectively displayed. Further, by hiding the sections unnecessary for search, larger display regions of the sections necessary for search may be secured. Therefore, the user may search for the desired image data more easily and rapidly.

<Other Operation Examples>

Next, various operation examples of the display control unit 9 are described. Note that, the above-mentioned basic operation and each operation example described below may be executed in combination as appropriate unless contradiction occurs.

[Automatic Selection of Representative Category]

First, an example of a method of automatically selecting the representative category by the display control unit 9 is described. In this example, the automatic selection method is a method of selecting a category having a high determination (designation) frequency as the representative category.

For example, the category which has the largest number of image data items belonging thereto may be selected as the representative category. In this case, in order to select the representative category, the display control unit 9 may refer to all the image data items stored in the storage unit 5, or refer to image data items in certain sections (for example, sections included in display image, that is, one month in FIG. 8).

Further, for example, in each section, a category (section category) which has the largest number of image data items belonging thereto, which may be displayed as the corresponding images, may be obtained, to thereby select a category which exhibits the highest count among the obtained section categories as the representative category. Specifically, for example, when the display image 200 illustrated in FIG. 8 is generated, in each day of the 1st to the 30th, the section category which has the largest number of image data items belonging thereto, which may be displayed as the corresponding images, may be obtained, and a category which exhibits the highest count among the obtained 30 section categories (less than 30 if there is a day when image data is not obtained by the image taking operation) may be selected as the representative category.

With this configuration, the category to which the image data desired by the user belongs with a strong possibility may be automatically selected as the representative category. Therefore, the search for the image data may be performed more easily and rapidly.

Note that, it is preferred that the automatic determination of the category of the image data be performed in the image analysis unit 2, because various instructions from the user with respect to the category of the image data are not required, and also the corresponding images of the image data items which may be desired by the user with a strong possibility may be displayed.

[Image Data Search]

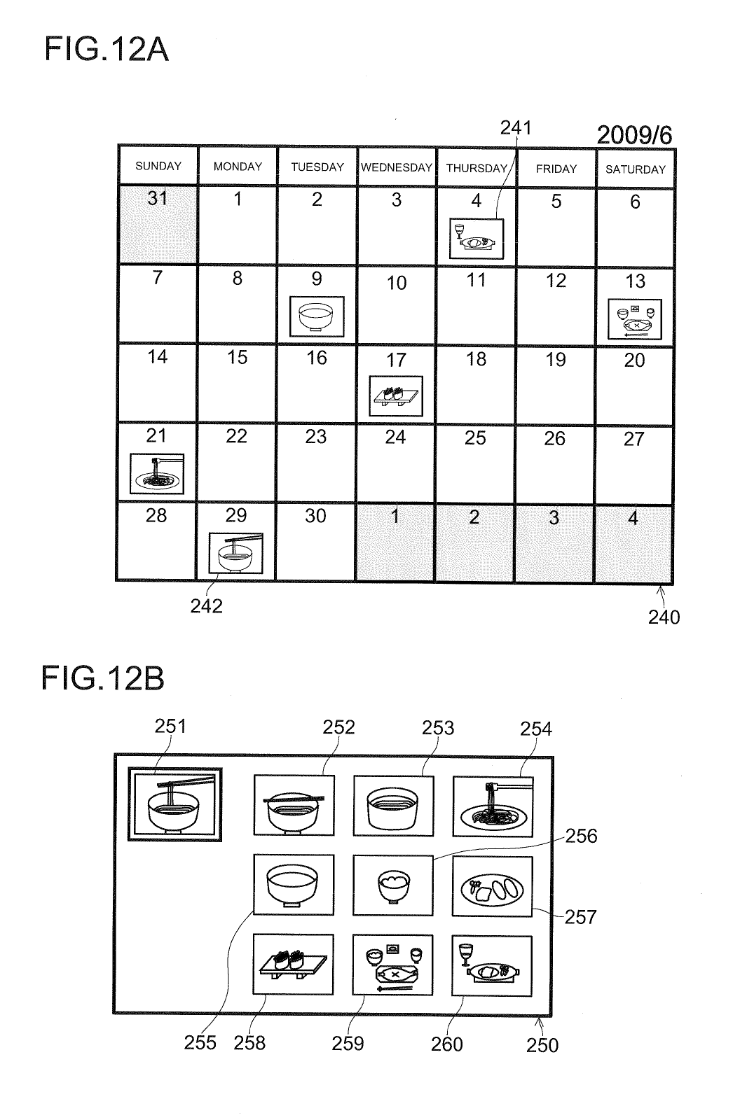

Next, an example of a method of searching for image data by the display control unit 9 is described with reference to the drawings. FIGS. 12A and 12B are diagrams illustrating the example of the method of searching for the image data. A display image 240 illustrated in FIG. 12A is similar to the display images 200 and 220 illustrated in FIGS. 8 and 10, and the representative category is “food”. Further, a display image 250 illustrated in FIG. 12B is an image displayed in a case where the user inputs a search instruction through the operation unit 8.

In the search method in this example, the user first selects image data which is similar to the desired image data from the corresponding images included in the display image 240 of FIG. 12A, and designates the image data through the operation unit 8. Hereinafter, a case where a corresponding image 242 of the 29th day is designated by the user is described as an example. In this case, search is performed by assuming the image data corresponding to the designated corresponding image 242 as a query.

Specifically, search is performed for the image data similar to the image data serving as the query. Whether or not the image data items are similar to each other may be determined by using, for example, the feature amounts illustrated in FIG. 5. Note that, in the search method in this example, the difference between the feature amount of the image of the image data serving as the query and the feature amount of the image of another image data is obtained. As the difference is smaller, it is determined that the image data items are similar to each other. Note that, whether or not the image data items are similar to each other may be determined based on the image taking information in addition to (or instead of) the feature amount of the image. For example, it may be determined that the image data items are more similar to each other as the image taking dates/times thereof or the image taking places thereof are nearer to each other. In particular, when the difference between the image taking dates/times or the image taking places of the compared image data items is smaller than a predetermined time period or a predetermined distance, it may be determined that the image data items are particularly similar to each other.

Further, as illustrated in FIG. 12B, the display control unit 9 generates the display image 250 showing a search result, and the display unit 10 displays the display image 250. The display image 250 includes a corresponding image 251 of the image data serving as the query, and corresponding images 252 to 260 of image data items similar to the image data serving as the query. The corresponding images 252 to 260 are aligned and displayed in accordance with the order of the image data items similar to the image data serving as the query. The display image 250 has the corresponding image 252 of the image data most similar to the image data serving as the query positioned at an upper left thereof. As the position of the corresponding image is shifted rightward and downward, the corresponding image of the image data becomes less similar to that of the image data serving as the query.

With the configuration described above, the search may be performed by using the image data corresponding to the designated corresponding image as the query. Therefore, the query may be designated intuitively and easily. As a result, easy and effective search may be performed.

Further, by displaying the corresponding images of the image data items obtained through the search arranged in the order of image data items similar to the image data serving as the query, the corresponding images may be displayed in order from the image data which may be desired by the user with a strong possibility. Therefore, the search for the desired image data may be performed easily and rapidly.

Note that, the image data items of search targets may be all the image data items stored in the storage unit 5, or the image data items belonging to the same category as the image data serving as the query. However, by searching the image data items widely, effective search may be performed. In particular, it is preferred to widely search the image data items without considering the sections included in the display image 240. Further, there may be a plurality of image data items serving as the query.

[Switching of Corresponding Image]

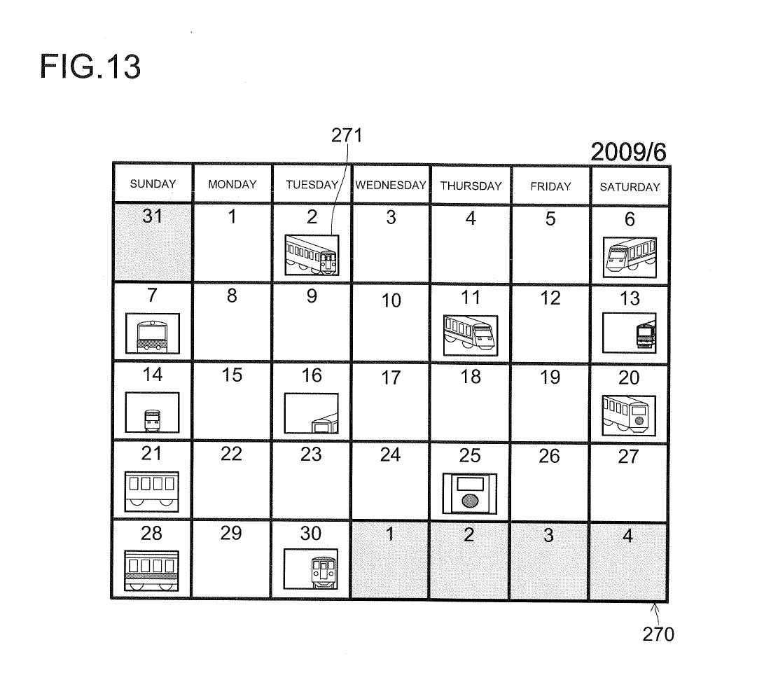

Next, an example of a method of switching the corresponding image by the display control unit 9 is described with reference to the drawing. FIG. 13 is a diagram illustrating an example of a display image generated by switching the display image illustrated in FIG. 8. Note that, also in a display image 270 illustrated in FIG. 13, the representative category is “train” similarly to the display image 200 of FIG. 8.

Switching is performed as follows. The user inputs a switching instruction to the display control unit 9 through the operation unit 8. For example, when the corresponding image of the image data desired by the user is not displayed in the display image 200 of FIG. 8, the user inputs the switching instruction.

After the switching instruction is input, the representative category and the sections are not changed but maintained, but the corresponding image 201 displayed in each section is changed. For example, displayed in each section is a corresponding image 271 of image data which is the second highest (or lowest) in score after the image data to which the corresponding image 201 displayed before the switching corresponds.

Note that, in the section in which the number of image data items which belong to the representative category and may be displayed as the corresponding images is equal to or lower than the number of corresponding images displayed at a time (one) (for example, 3rd to 6th days in display image 270 of FIG. 13), switching is not performed because there is no corresponding image switchable.

With this configuration, even if the number of corresponding images displayed at a time in each section is small, by sequentially performing the switching, a large number of corresponding images may be displayed. Therefore, the corresponding images of the image data items belonging to the representative category may be viewed easily by the user.

Note that, as illustrated in FIG. 13, the switching may be performed to all the sections which are switchable (for example, 2nd day of display image 270 of FIG. 13) among the sections included in the display images 200 and 270. With this configuration, a large number of corresponding images may be switched at a time, and hence the user may easily and rapidly view the corresponding images.

Further, the switching may be performed only to one or a plurality of sections designated by the user. With this configuration, when the user almost surely remembers the image taking date/time of the desired image data, useless switching may be prevented.

[Generation of Display Image in Spatial Sections]

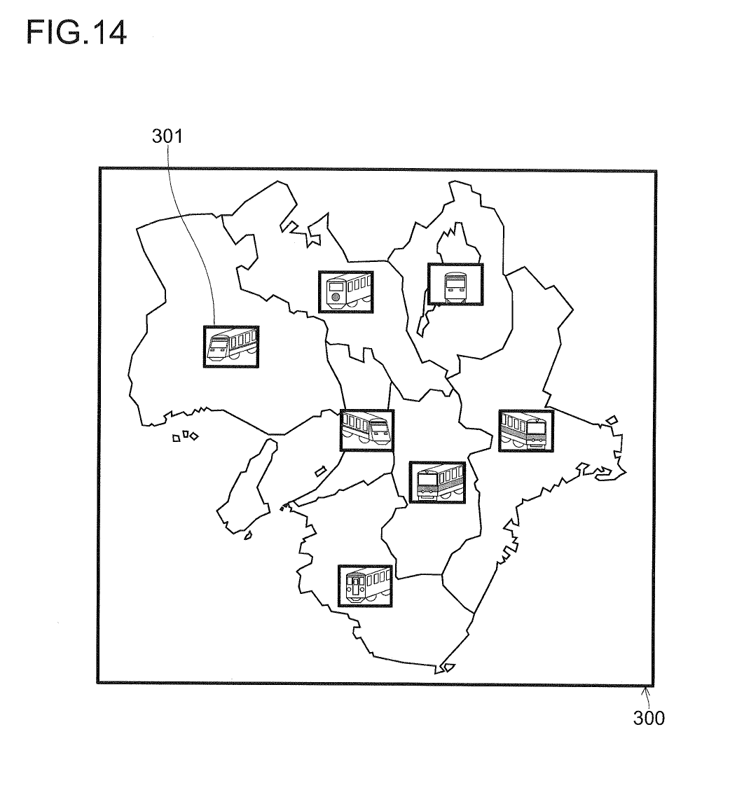

Referring to the display images 200, 220, 230, 240, and 270 of FIG. 8 and FIGS. 10 to 13, the display method of displaying the corresponding images 201, 221, 231, 241, and 271 in temporal sections has been described. Alternatively, a display image showing corresponding images in spatial sections may be generated as described above. Here, a display image showing the corresponding images in spatial sections is described with reference to the drawing. FIG. 14 is a diagram illustrating an example of the display image showing the corresponding images in spatial sections. Note that, the representative category of a display image 300 illustrated in FIG. 14 is “train” similarly to the display image 200 of FIG. 8.

The display image 300 illustrated in FIG. 14 represents one region and includes sections of prefectures. In order to generate the display image 300 illustrated in FIG. 14, the display control unit 9 refers to the image taking place among the pieces of image taking information of the image data. Further, based on the image taking place thus referred to, the display control unit 9 determines whether or not the corresponding image of the image data may be displayed in a certain prefecture in the display image 300 of FIG. 14. Specifically, if the image data is taken at the certain prefecture, the corresponding image thereof is determined as an image which may be displayed in the certain prefecture.

In addition, among the images determined as the corresponding images which may be displayed in the certain prefecture, the display control unit 9 selects and displays the corresponding image belonging to the representative category preferentially.

Also in the case of displaying a corresponding image 301 in the spatial section, the display image 300 displayed on the display unit 10 is an image in which the corresponding images 301 belonging to the representative category are displayed preferentially. Therefore, the corresponding images 301 of the image data items belonging to the same category as that of the image data desired by the user may be displayed preferentially. Therefore, the user may search for the desired image data easily and rapidly.

Note that, various display methods and selection methods described to be applied to the temporal sections may be applied to the spatial sections as well. Further, sections may be both temporal and spatial. For example, sections may be defined by temporally dividing each section of the display image 300 of FIG. 14.

<<Modified Example>>

In the image display device 1 according to the embodiment of the present invention, the operation of the display control unit 9 may be executed by a control device such as a microcomputer. In addition, all or some of functions implemented by such a control device may be written as a program, and by running the program on a program executing device (for example, computer), the all or some of the functions may be implemented.

Further, the present invention is not limited to the above-mentioned case, and the image display device 1 of FIG. 1 may be implemented by hardware alone or a combination of hardware and software. When software is used as a component of the image display device 1, a block diagram of a part that is implemented by the software is drawn as a function block diagram of the part.

In the above, the embodiment of the present invention has been described above. However, the scope of the present invention is not limited thereto, and the present invention may be implemented with being subjected to various modifications without departing from the gist of the present invention.

The present invention is applicable to an image display device which displays an image, as typified by a display unit of an image taking device or a viewer.

What is claimed is:

1. An image display device, comprising a display unit which displays corresponding images corresponding to image data items classified into categories,
wherein the display unit preferentially displays a corresponding image corresponding to an image data item which belongs to a representative category selected from the categories.

2. An image display device according to claim 1, wherein:
the display unit displays each of the corresponding images in each temporal section, the each temporal section, in which the each of the corresponding images is displayed, being determined based on a date and time when each of the image data items is obtained by an image taking operation; and
when there are a plurality of image data items to be displayed as corresponding images in the same temporal section, and when the plurality of image data items include the image data item which belongs to the representative category and an image data item which does not belong to the representative category, the corresponding image of the image data item which belongs to the representative category is displayed and a corresponding image of the image data item which does not belong to the representative category is prevented from being displayed.

3. An image display device according to claim 1, further comprising a selection unit which selects the representative category from the categories,
wherein the selection unit selects, as the representative category, a category into which the image data items are frequently classified.

4. An image display device according to claim 1, further comprising:
a storage unit which stores the image data items;
a search unit which searches the image data items stored in the storage unit; and
an input unit through which an instruction to designate at least one of the corresponding images displayed on the display unit is input, wherein:
the search unit searches the storage unit for an image data item similar to an image data item to which the at least one of the corresponding images designated by the instruction input through the input unit corresponds; and
the display unit displays a corresponding image of the image data item that the search unit has searched for.

5. An image display device according to claim 1, further comprising a switching unit which switches among the corresponding images displayed on the display unit,
wherein the display unit displays a corresponding image switched by the switching unit, which is the corresponding image of the image data item which belongs to the representative category.

6. An image display device according to claim 1, wherein:
the display unit displays each of the corresponding images in each spatial section, the each spatial section, in which the each of the corresponding images is displayed, being determined based on a place where each of the image data items is obtained by an image taking operation; and
when there are a plurality of image data items to be displayed as corresponding images in the same spatial section, and when the plurality of image data items include the image data item which belongs to the representative category and an image data item which does not belong to the representative category, the corresponding image of the image data item which belongs to the representative category is displayed and a corresponding image of the image data item which does not belong to the representative category is prevented from being displayed.
